(19) United States
(12) Patent Application Publication
(10) Pub. No.: US 2020/0400506 A1
(43) Pub. Date: Dec. 24, 2020

(54) MULTIPLE TEMPERATURE PROBE ADAPTER SYSTEM

(71) Applicant: Justin Chasteen, Sioux City, IA (US)

(72) Inventor: Justin Chasteen, Sioux City, IA (US)

(21) Appl. No.: 16/445,436

(22) Filed: Jun. 19, 2019

(51) Int. Cl. G01K 1/02; G01K 3/10

(52) U.S. Cl. CPC G01K 1/026; G01K 3/10

(57) ABSTRACT

A multiple temperature probe adapter system converts a single temperature probe device to use multiple probes. The system includes a device having a temperature probe input port and a plurality of temperature probes. Each of a plurality of probe inputs is positioned on a housing. Each of the temperature probes is communicatively coupled to a respective one of the probe inputs. A single probe output is positioned on the housing to be connected to the temperature probe input port of the device. Each of the probe inputs is communicatively coupled to a processor which is communicatively coupled to the single probe output. The processor delivers individual respective temperature readings from each of the temperature probes through the single probe output to the device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to temperature probe device and more particularly pertains to a new temperature probe adapter system for converting a device having a single probe for use with multiple temperature probes.

### (2) Description of Related Art Including Information Disclosed Under 37 CFR 1.97 and 1.98

The prior art relates to temperature probe devices.

### BRIEF SUMMARY OF THE INVENTION

An embodiment of the disclosure meets the needs presented above by generally comprising a device having a temperature probe input port and a plurality of temperature probes. Each of a plurality of probe inputs is positioned on a housing. Each of the temperature probes is communicatively coupled to a respective one of the probe inputs. A single probe output is positioned on the housing to be connected to the temperature probe input port of the device. Each of the probe inputs is communicatively coupled to a processor which is communicatively coupled to the single probe output. The processor delivers individual respective temperature readings from each of the temperature probes through the single probe output to the device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom front side perspective view of a multiple temperature probe adapter system according to an embodiment of the disclosure.

FIG. 2 is a rear bottom view of an embodiment of the disclosure.

FIG. 3 is a front view of an embodiment of the disclosure.

FIG. 4 is a bottom view of an embodiment of the disclosure.

FIG. 5 is a schematic view of an embodiment of the disclosure.

### DETAILED DESCRIPTION OF THE INVENTION

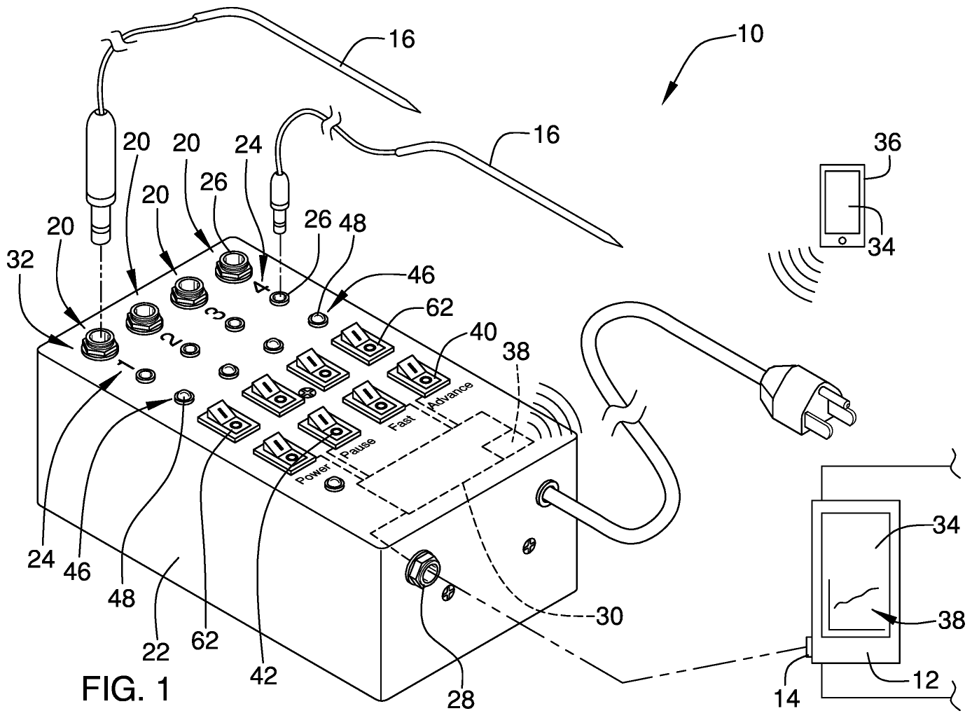

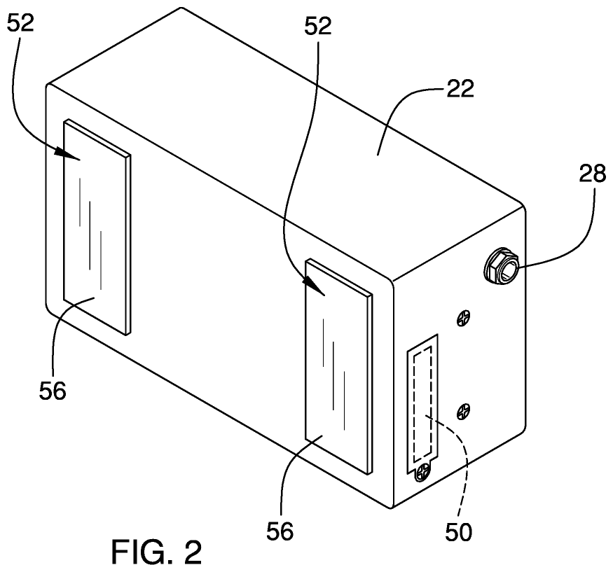

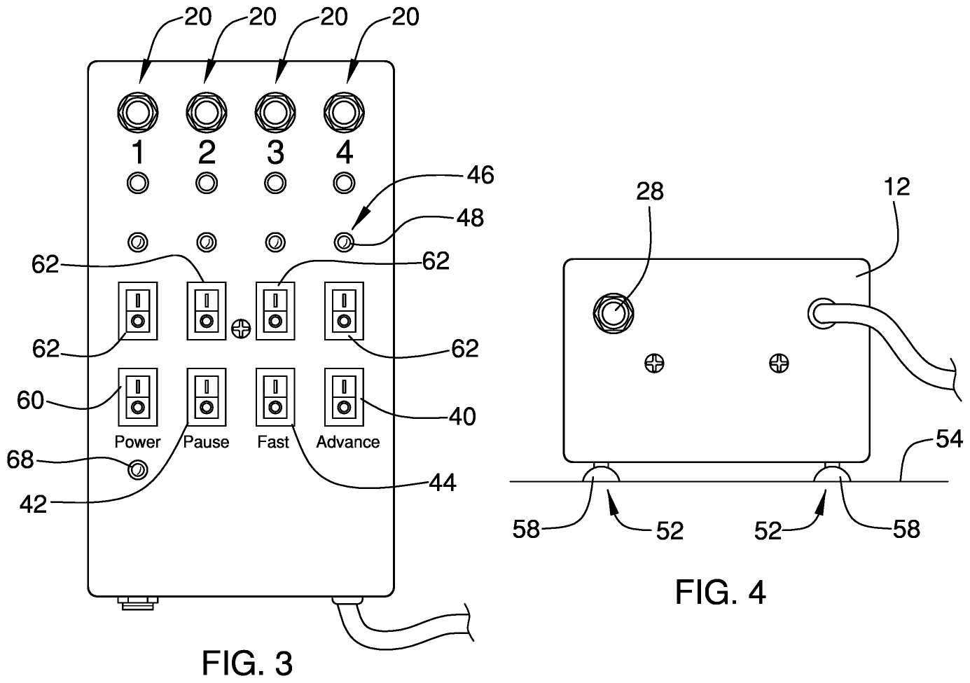

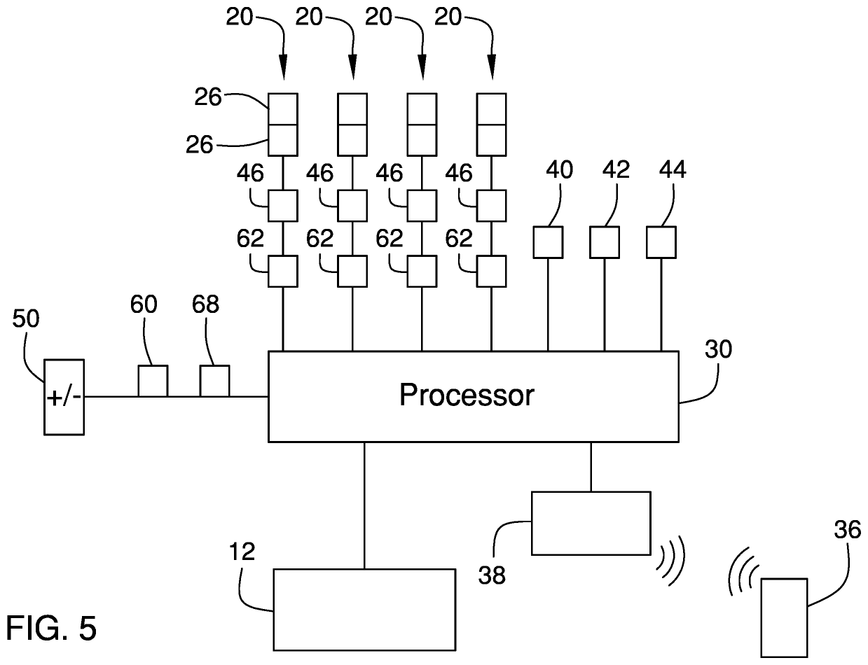

With reference now to the drawings, and in particular to FIGS. 1 through 5 thereof, a new temperature probe device embodying the principles and concepts of an embodiment of the disclosure and generally designated by the reference numeral 10 will be described.

As best illustrated in FIGS. 1 through 5, the multiple temperature probe adapter system 10 generally comprises a device 12 having at least one temperature probe input port 14 which may be extrinsic to or incorporated into a cooker, smoker, oven, or the like. It is contemplated that the device 12 may have more than one temperature probe input port 14 but the general purpose of the system 10 is to allow for use of a plurality of temperature probes 16 with a single temperature probe input port 14. The system 10 incorporates a plurality of probe inputs 20 positioned on a housing 22. Each of the temperature probes 18 is communicatively coupled to a respective one of the probe inputs 20. The probe inputs 20 are sequentially numbered with indicia 24 being positioned adjacently on the housing 22. Each of the probe inputs 20 may comprise a specific conventional sized temperature input connection port 26 or a plurality of input connection ports 26 each being uniquely sized relative to each other to allow for interchangeable use of temperature probes 16 having different sized connections at each probe input 20. The drawing figures show two sizes but there can be additional sizes utilized separately or in combination to provide maximum flexibility in attaching temperature probes 16. A single probe output 28 is positioned on the housing 22. The single probe output 28 is used to connect to the temperature probe input port 14 of the device 12. The drawing figures provide four probe inputs 20 but it is to be understood any desired number may be provided to allow for monitoring the temperature in a multitude of places.

A processor 30 is positioned within the housing 22. Each of the probe inputs 20 is communicatively coupled to the processor 30. The processor 30 is communicatively coupled to the single probe output 28 wherein the processor 30 delivers individual respective temperature readings from each of the temperature probes 16 through the single probe output 28. The individual respective temperature readings are delivered through the single probe output 28 sequentially in accordance with numbering of the probe inputs 22. The processor 30 designates a lowest numbered probe input engaged by one of the temperature probes 16 as a primary input 32. The individual respective temperature reading from the primary input 32 is delivered through the single probe output 28 for a duration of time longer than a duration of time for each other individual respective temperature reading. The duration of time the individual respective temperature reading of the primary input 32 is delivered by the processor may be at least twice the duration of time for each other individual respective temperature reading. The processor 30 refreshes designation of the primary input 32 to a new lowest numbered one of the probe inputs 20 when the temperature probe 16 communicatively coupled to the primary input 32 is disconnected. Thus, when multiple temperature probes 16 are connected, the processor 30 will always have a designated primary input 32 which is the lowest of the sequentially numbered probe inputs 20 to have a connected temperature probe 16. The individual respective temperature readings delivered by the processor 30 are communicated to a graphic display 34 of the device 12 or another extrinsic device 36. The processor 30 may also be operationally coupled to a transmitter 38 within the housing 22 to provide for wireless connectivity to the extrinsic device 36. The graphic display 34 in turn sequentially displays a respective temperature over time graph 38 for each of the probe inputs 20.

A cycle advance button 40 is positioned on the housing 22. The cycle advance button 40 is operationally coupled to the processor 30. The processor 30 advances from a currently displayed individual respective temperature reading of the probe inputs 20 to the individual respective temperature reading of the next sequential probe unit 20 in accordance with the numbering of the probe inputs 20 when the cycle advance button 40 is actuated. This allows a user to control display of the associated temperature associated with a selectable one of the probe units 20.

A pause button 42 is positioned on the housing 22. The pause button 42 is operationally coupled to the processor 30. The processor 30 pauses sequential delivery of the individual respective temperature readings wherein the processor 30 delivers only the individual respective temperature reading of the specific temperature probe 16 associated with the probe input 20 being delivered through the single probe output 28 when the pause button 42 is actuated.

A speed button 44 is positioned on the housing 22. The speed button 44 is operationally coupled to the processor 30. The processor 30 adjusts a duration for delivering each individual respective temperature reading when the speed button 44 is actuated. This allows the user to control how fast the processor moves the sequence of probe inputs 20. The speed button may be a two position button or two state single button wherein the processor 30 alternates between a slow speed and a fast speed when the speed button 44 is actuated. The duration for delivering each individual respective temperature reading for each probe input 20 at the fast speed is less than the duration for delivering each individual respective temperature reading for each probe input 20 at the slow speed. The duration of delivery by the processor 30 may alternatively be adjusted or customized using a continuous adjustment between minimum and maximum durations by either a physical dial, or the like, or through adjustable programming of the processor 30.

A plurality of indicators 46 is positioned on the housing 22. Each of the indicators 46 is associated with a respective one of the probe inputs 20. Each of the indicators 46 indicates when one of the temperature probes 16 is connected to the associated one of the probe inputs 20. Each of the indicators 46 may be a light 48 such as a light emitting diode or the like. The light 48 may be illuminated when the one of the temperature probes 16 is connected to the associated one of the probe inputs 20.

A battery 50 is positioned within the housing 22. The battery 50 is electrically coupled to the processor 30. The battery 50 may be rechargeable and/or replaceable. Alternatively, the processor 30 may be powered by a wired connection to a power source such as a conventional electrical outlet. A fastener 52 is coupled to the housing 22 wherein the housing 22 is configured for being coupled to a support structure 54 which may be the device 12 or another adjacently positioned structure. The fastener 52 may be either a magnet 56 or a suction cup 58. Both a magnet 56 and one of more suction cups 58 may be provided.

A main power switch 60 is positioned on the housing 22. The main power switch 60 is operationally coupled to the processor 30. The main power switch 60 is electrically coupled between the processor 30 and the battery 50 or other power source.

The system 10 may include a plurality of probe input activation switches 62. Each probe input activation switch 62 is communicatively coupled between the processor 30 and an associated one of the probe inputs 20 wherein each probe input 20 is selectively operationally coupled to the processor 30 while one of the temperature probes 16 is communicatively coupled to the probe input 20. Thus, each probe input 20 may be selectively disconnected from the processor 30 instead of by disconnection from the associated temperature probe 16. The associated light 48 may be turned off when the probe input activation switch 62 for the particular probe input 20 is in a deactivating position. Each individual temperature probe 16 may be selectively activated and deactivated during a cooking session without having to disconnect the temperature probe 16 from the probe input 20.

In use, the system 10 positions the housing 22 in a serial connection between temperature probes 16 and the device 12 into the single temperature probe input port 14. The processor 30 delivers sequential output from temperature probes 16 respective to each active probe input 20. The output is displayed typically through the existing display program for a single temperature probe input but cycles through as described above so that a temperature corresponding to each of the multiple temperature probes is displayed. In accordance with a display program the graphical display can be viewed on the device 12 or another extrinsic device such as a cellular phone through internet, local networking, or cellular communications.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A multiple temperature probe adapter system comprising:
a device having a temperature probe input port;
a plurality of temperature probes;
a housing;
a plurality of probe inputs positioned on said housing, each of said temperature probes being communicatively coupled to a respective one of said probe inputs;
a single probe output positioned on said housing;
a processor positioned within said housing, each of said probe inputs being communicatively coupled to said processor, said processor being communicatively coupled to said single probe output wherein said processor is configured to deliver individual respective temperature readings from each of said temperature probes through said single probe output.

2. The system of claim 1, further comprising said probe inputs being sequentially numbered.

3. The system of claim 2, further comprising said individual respective temperature readings being delivered through said single probe output sequentially in accordance with numbering of said probe inputs.

4. The system of claim 3, further comprising said processor designating a lowest numbered probe input engaged by one of said temperature probes as a primary input, said individual respective temperature reading from said primary input being delivered through said single probe output for a duration of time longer than a duration of time for each other individual respective temperature reading.

5. The system of claim 4, further comprising said duration of time said individual respective temperature reading of said primary input is delivered by said processor being at least twice said duration of time for each other individual respective temperature reading.

6. The system of claim 4, further comprising said processor refreshing designation of said primary input to a new lowest numbered one of said probe inputs when said temperature probe communicatively coupled to said primary input is disconnected.

7. The system of claim 1, further comprising each of said probe inputs comprising a plurality of input connection ports, said input connection ports of each said probe input being uniquely sized relative to each other.

8. The system of claim 3, further comprising a cycle advance button positioned on said housing, said cycle advance button being operationally coupled to said processor, said processor advancing to a next said individual respective temperature reading in accordance with said numbering of said probe inputs when said cycle advance button is actuated.

9. The system of claim 3, further comprising a pause button positioned on said housing, said pause button being operationally coupled to said processor, said processor pausing sequential delivery of said individual respective temperature readings wherein said processor delivers only said individual respective temperature reading being delivered when said pause button is actuated.

10. The system of claim 3, further comprising a speed button positioned on said housing, said speed button being operationally coupled to said processor, said processor adjusting a duration for delivering each individual respective temperature reading when said speed button is actuated.

11. The system of claim 10, further comprising said processor alternating between a slow speed and a fast speed when said speed button is actuated, said duration for delivering each individual respective temperature reading for each probe input at said fast speed being less than said duration for delivering each individual respective temperature reading for each probe input at said slow speed.

12. The system of claim 1, further comprising said individual respective temperature readings delivered by said processor being communicated to a graphic display of an extrinsic electronic device, said graphic display displaying a respective temperature over time graph for each of said probe inputs.

13. The system of claim 1, further comprising a plurality of indicators positioned on said housing, each of said indicators being associated with a respective one of said probe inputs, each of said indicators indicating when one of said temperature probes is connected to said associated one of said probe inputs.

14. The system of claim 13, further comprising each of said indicators being a light, said light being illuminated when said one of said temperature probes is connected to said associated one of said probe inputs.

15. The system of claim 1, further comprising a battery positioned within said housing, said battery being electrically coupled to said processor.

16. The system of claim 1, further comprising a fastener being coupled to said housing wherein said housing is configured for being coupled to a support structure.

17. The system of claim 16, further comprising said fastener being one of a magnet and a suction cup.

18. The system of claim 3, further comprising a main power switch positioned on said housing, said main power switch being operationally coupled to said processor.

19. The system of claim 3, further comprising a plurality of probe input activation switches, each probe input activation switch being communicatively coupled between said processor and an associated one of said probe inputs wherein each probe input is selectively operationally coupled to said processor while one of said temperature probes is communicatively coupled to said probe input.

20. A multiple temperature probe adapter system comprising:
a device having a temperature probe input port;
a plurality of temperature probes;
a housing;
a plurality of probe inputs positioned on said housing, each of said temperature probes being communicatively coupled to a respective one of said probe inputs, said probe inputs being sequentially numbered, each of said probe inputs comprising a plurality of input connection ports, said input connection ports of each said probe input being uniquely sized relative to each other;
a single probe output positioned on said housing;
a processor positioned within said housing, each of said probe inputs being communicatively coupled to said processor, said processor being communicatively coupled to said single probe output wherein said processor is configured to deliver individual respective temperature readings from each of said temperature probes through said single probe output, said individual respective temperature readings being delivered through said single probe output sequentially in accordance with numbering of said probe inputs, said processor designating a lowest numbered probe input engaged by one of said temperature probes as a primary input, said individual respective temperature reading from said primary input being delivered through said single probe output for a duration of time longer than a duration of time for each other individual respective temperature reading, said duration of time said individual respective temperature reading of said primary input is delivered by said processor being at least twice said duration of time for each other individual respective temperature reading, said processor refreshing designation of said primary input to a new lowest numbered one of said probe inputs when said temperature probe communicatively coupled to said primary input is disconnected, said individual respective temperature readings delivered by said processor being communicated to a graphic display of an extrinsic electronic device, said graphic display displaying a respective temperature over time graph for each of said probe inputs;
a cycle advance button positioned on said housing, said cycle advance button being operationally coupled to said processor, said processor advancing to a next said individual respective temperature reading in accordance with said numbering of said probe inputs when said cycle advance button is actuated;
a pause button positioned on said housing, said pause button being operationally coupled to said processor, said processor pausing sequential delivery of said individual respective temperature readings wherein said processor delivers only said individual respective temperature reading being delivered when said pause button is actuated;
a speed button positioned on said housing, said speed button being operationally coupled to said processor, said processor adjusting a duration for delivering each individual respective temperature reading when said speed button is actuated, said processor alternating between a slow speed and a fast speed when said speed button is actuated, said duration for delivering each individual respective temperature reading for each probe input at said fast speed being less than said duration for delivering each individual respective temperature reading for each probe input at said slow speed;
a plurality of indicators positioned on said housing, each of said indicators being associated with a respective one of said probe inputs, each of said indicators indicating when one of said temperature probes is connected to said associated one of said probe inputs, each of said indicators being a light, said light being illuminated when said one of said temperature probes is connected to said associated one of said probe inputs;
a battery positioned within said housing, said battery being electrically coupled to said processor;
a fastener being coupled to said housing wherein said housing is configured for being coupled to a support structure, said fastener being one of a magnet and a suction cup;
a main power itch positioned on said housing, said main power switch being operationally coupled to said processor; and
a plurality of probe input activation switches, each probe input activation switch being communicatively coupled between said processor and an associated one of said probe inputs wherein each probe input is selectively operationally coupled to said processor while one of said temperature probes is communicatively coupled to said probe input.
